(19) United States
(12) Patent Application Publication
(10) Pub. No.: US 2017/0032363 A1
(43) Pub. Date: Feb. 2, 2017

(54) METHOD FOR MAPPING DATA TO A TRANSACTION

(71) Applicant: MasterCard International Incorporated, Purchase, NY (US)

(72) Inventors: Suneel BHATT, Delhi (IN); Ankur ARORA, Jasola (IN); Priyanka TANEJA, Gurgaon (IN)

(73) Assignee: MasterCard International Incorporated, Purchase, NY (US)

(21) Appl. No.: 15/218,435

(22) Filed: Jul. 25, 2016

(30) Foreign Application Priority Data
Jul. 27, 2015 (SG) 10201505846P

(51) Int. Cl. G06Q 20/36; G06Q 30/02; G06Q 20/02

(52) U.S. Cl. CPC G06Q 20/3672; G06Q 20/027; G06Q 30/0253

(57) ABSTRACT

The method includes generating a token using a token generator, the token being associated with time data and a transaction modifier, and using an advertiser system in communication with the token generator to associate the token with an advertisement displayed at a time of display corresponding with the time data. A transaction is then established using a payment gateway upon receiving a transaction request, relating to the advertised content. The transaction is then executed, through the payment gateway, with initial payment credentials if the token is not supplied while establishing the transaction, and executing a transaction, through the payment gateway, with modified payment credentials if the token is supplied while establishing the transaction. A data tuple is the received and stored, at a data repository, the data tuple comprising a record of the transaction, the advertised content and at least one of the time data and the time of display.

### TECHNICAL FIELD

The present disclosure relates to methods for mapping data to a transaction. The present disclosure is particularly, though not exclusively, applicable to correlating transactions stemming from advertisements to the time at which those advertisements were displayed, the application of discounts and other transaction modifiers.

### BACKGROUND

There is currently some difficulty in determining the catalyst for purchase transactions. That catalyst may be, for example, a spontaneous desire to purchase goods or services, a need to replace an existing product, and a purchase catalysed in response to an advertisement.

Additionally, when a purchase is made in response to an advertisement it is difficult to determine which advertising medium and timeslot is responsible for the purchase. This issue is particularly acute for companies that advertise over multiple advertising media, channels and timeslots.

It is desired therefore to provide a means for more readily determining the advertising medium, timeslot and channel that catalysed a particular purchase.

### SUMMARY

The present disclosure provides a method for mapping data to a transaction, comprising:
generating a token using a token generator, the token being associated with time data and a transaction modifier;
using an advertiser system in communication with the token generator to associate the token with an advertisement displayed at a time of display corresponding with the time data, the advertisement comprising advertised content received from one or more merchant systems;
establishing a transaction using a payment gateway upon receiving a transaction request, through a client system on which the advertisement is displayable or a respective said merchant system, relating to the advertised content;
executing the transaction, through the payment gateway, with initial payment credentials if the token is not supplied while establishing the transaction, and executing a transaction, through the payment gateway, with modified payment credentials if the token is supplied while establishing the transaction, the modified payment credentials being based on the initial payment credentials and the transaction modifier which modifies the initial payment credentials;
receiving and storing, at a data repository, a data tuple comprising a record of the transaction, the advertised content and at least one of the time data and the time of display;
repeating the above steps for multiple tokens;
analysing, at the advertiser system or the respective merchant system, the data tuples from the data repository to generate a number of transactions for each time of display; and
   displaying the number of transactions and times of display on a display associated with the advertiser system or the respective merchant system, to enable visual identification of peaks and troughs in the transaction frequency data.

The present disclosure further provides a system for mapping data to a transaction, comprising:
a data repository for storing data tuples;
an advertiser system;
at least one merchant system;
a display associated with one of the advertiser and respective merchant system;
a token generator;
a client system; and
a payment gateway;
   wherein:
the client system is configured to display an advertisement;
the respective merchant system is configured to send to advertised content to the advertiser system;
   wherein at least one of the client system and respective merchant system is configured to send a transaction request to the payment gateway;
the token generator is configured to generate a token, the token being associated with time data and a transaction modifier;
the advertiser system is in communication with the token generator and configured to receive the token and associate the token with the advertisement, the advertisement being displayed at a time of display corresponding with the time data and comprising the advertised content;
the payment gateway is configured to establish a transaction upon receiving the transaction request from the client system or respective merchant system, relating to the advertised content, the payment gateway also being configured to execute the transaction with initial payment credentials if the token is not supplied while establishing the transaction, and with modified payment credentials if the token is supplied while establishing the transaction, the modified payment credentials being based on the initial payment credentials and the transaction modifier which modifies the initial payment credentials;
the data repository is configured to receive and store a data tuple comprising a record of the transaction, the advertised content and at least one of the time data and the time of display, along with a plurality of other data tuples similarly generated by the token generator, advertiser system, payment gateway, client system and respective merchant system;
   wherein at least one of the advertiser system and respective merchant system is configured to analyse the data tuples from the data repository to generate a number of transactions for each time of display; and
the display is configured to display the number of transactions and times of display to enable visual identification of peaks and troughs in the transaction frequency data.

The present disclosure still further provides a computer program embodied on a non-transitory computer readable medium for mapping data to a transaction, the program comprising at least one code segment executable by a computer to instruct the computer to:
generate a token using a token generator, the token being associated with time data and a transaction modifier;
use an advertiser system in communication with the token generator to associate the token with an advertisement displayed at a time of display corresponding with the time data, the advertisement comprising advertised content received from one or more merchant systems;
establish a transaction using a payment gateway upon receiving a transaction request, through a client system on which the advertisement is displayable or a respective said merchant system, relating to the advertised content;
execute the transaction, through the payment gateway, with initial payment credentials if the token is not supplied while establishing the transaction, and execute a transaction, through the payment gateway, with modified payment credentials if the token is supplied while establishing the transaction, the modified payment credentials being based on the initial payment credentials and the transaction modifier which modifies the initial payment credentials;
receive and store, at a data repository, a data tuple comprising a record of the transaction, the advertised content and at least one of the time data and the time of display;
repeat the above steps for multiple tokens;
analyse, at the advertiser system or the respective merchant system, the data tuples from the data repository to generate a number of transactions for each time of display; and
   display the number of transactions and times of display on a display associated with the advertiser system or the respective merchant system, to enable visual identification of peaks and troughs in the transaction frequency data.

In the present disclosure, the following terms have the meaning given here unless context dictates otherwise:
“supplying” a token can include manual input of a token code, but can also include the inadvertent or automatic supply of a token. Inadvertent or automatic supply may occur, for example, where the token comprises hidden data in an interactive advertisement. In such cases, the hidden data is automatically supplied to a payment gateway or merchant site when the interactive advertisement is activated or selected (e.g. using a mouse to select online content).
“comparable time of display”, in respect of a future/previous time of display, means an earlier/later time of display that can be reasonably equated to the future/previous time of display. For example, a comparable time of display for a future time of display of 8 pm on Wednesday, 15 Feb. 2012 may be any other Wednesday around 8 pm. Depending on the type of product (e.g. for seasonal products such as clothing and firewood), a comparable time of display may instead be a Wednesday afternoon in February, or even a time around 8 pm on a particular day, workday or weekend day.
“payment credentials” means at least one of a quantity of a product or service being acquired by a particular transaction, a transaction amount, additional products provided for free or at a discount along with purchase of a particular product, a postal service speed or the use of registered post to deliver a product, and so forth. The term “payment credentials” may be interchangeably used with “payment details”.
“advertisement” will be taken to mean the displayed (i.e. advertised) content along with any supporting information, hidden or otherwise. Similarly, the advertised content is not limited to periods during which products or services are displayed. The advertisement may instead be broken into segments with one segment, for example, displaying a product or service and a later segment displaying contact details. All such segments constitute displayed or advertised content. Where a token is displayed it can be displayed over one or multiple segments and all such display is intended to be described by the token being ‘associated with’ the advertisement.
“advertised content” may be a particular product or service. Where a category of goods or services, or a brand, is displayed the advertised content may include all goods or services of that category or brand.

### BRIEF DESCRIPTION OF THE DRAWINGS

Some embodiments of the methods taught herein will now be described, by way of non-limiting example only, with reference to the accompanying drawings in which:

FIG. 1 is a schematic process flow to mapping data to a transaction;

FIG. 2 illustrates a payment gateway;

FIG. 3 illustrates a variation in overall transaction numbers over a 24-hour period;

FIGS. 4(a) and 4(b) illustrate the variation in transaction numbers over a 24-hour period for various advertising media;

FIGS. 5(a) and 5(b) illustrate the variation in transaction numbers over a 24-hour period for various advertising channels on particular advertising media;

FIG. 6 illustrates the variation in mean transaction per display dollar and transaction per advertising medium against overall mean; and

FIG. 7 shows an illustrative embodiment of a system over which the presently taught methods may be performed.

### DETAILED DESCRIPTION

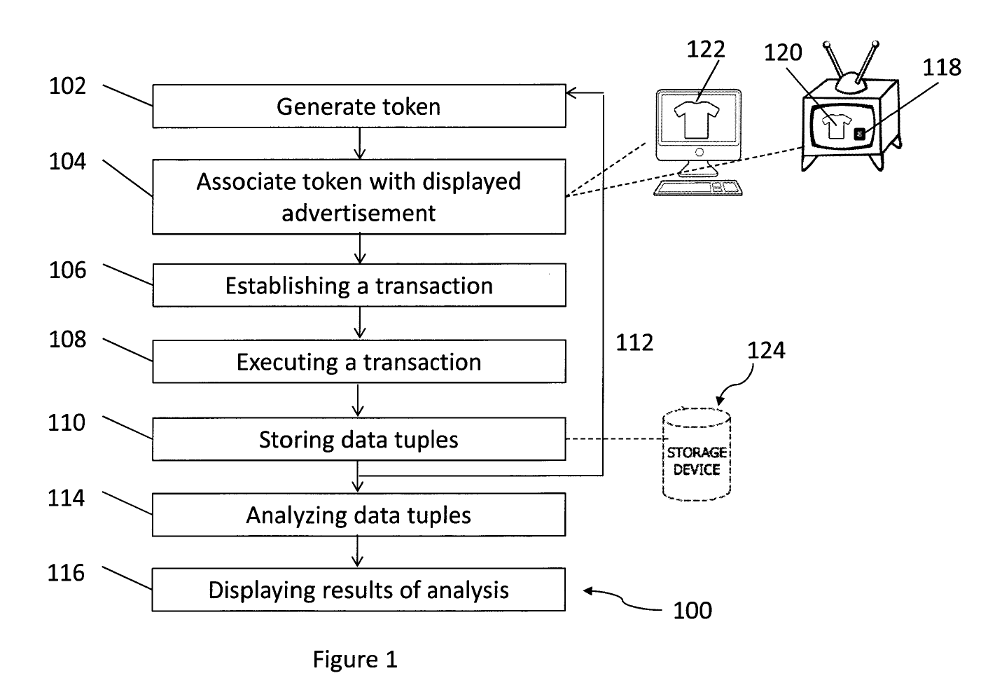

A method 100 for mapping data to transactions is shown in FIG. 1. The method 100 involves:
generating a token 102;
associating the token with a displayed advertisement 104;
establishing a transaction 106;
executing a transaction 108;
storing data tuples 110;
(repeating the above steps) 112;
analysing data 114; and
displaying number of transactions and times of display 116.

A token is a mechanism, such as a data structure or indicium, that can be associated with various pieces of data (hereinafter “token data”). The token data include time data to be associated with a time of display of an advertisement. The token data also include a payment modifier that modifies payment credentials for a transaction established (and executed) using the token. The token may also include information such a medium information describing the advertising medium on which the advertisement is to be displayed, and channel information describing the channel of the advertising medium.

The token is associated with a transaction thereby to associate the transaction with a particular time of display of an advertisement. It achieves this by being associated with transactions stemming from the advertisement such that the transaction is associated with time data of the token which itself is associated with the time of display of the advertisement. Thus a merchant or advertiser can determine which times for displaying advertisements are more likely to yield transactions than other times during which advertisements may be displayed. Similarly, an advertising medium provider can price the display of advertisements based on the likelihood of yielding a transaction for a particular time of display.

The form taken for the step of generating a token 102 depends on the manner in which the token will be used. Some tokens, such as token 118, will constitute a visual element of the advertised content 120 of an advertisement. This is because the content 120 is non-interactive and thus the user is a passive observer of the advertisement until a transaction is established. Such a token 118 may be an alphanumeric code, an alphabetical code, or any other type of mark or indicium that can be reproduced by a viewer of the advertisement at a later point in time (e.g. an hour after the advertisement has finished being displayed). Tokens that are visual elements of non-interactive advertisements may be entered manually into a payment webpage (e.g. a payment gateway) when establishing a transaction, so as to modify the credentials for the transaction.

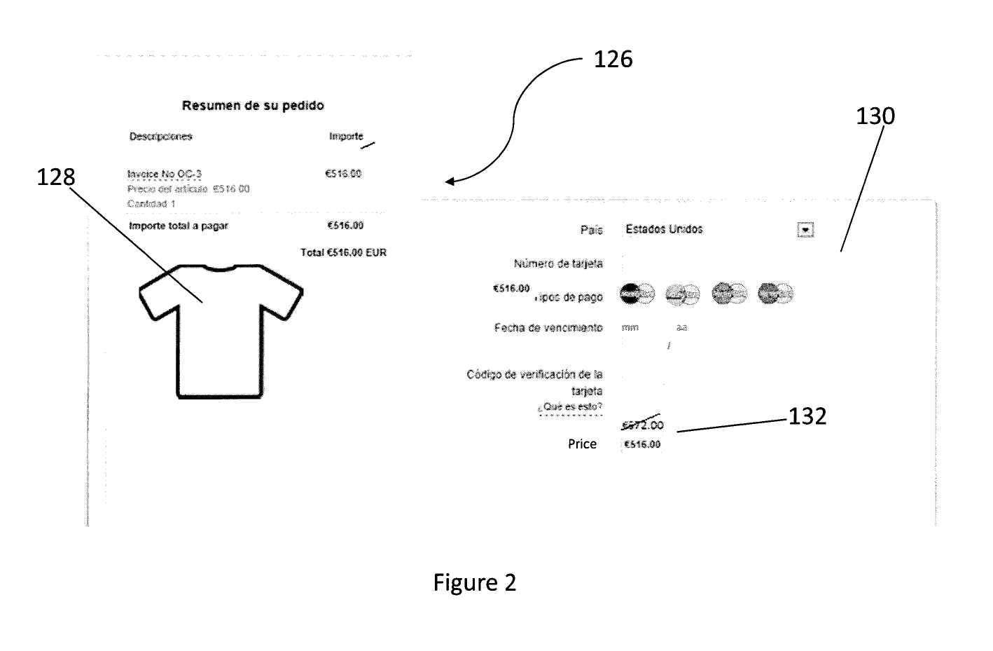

An alternative form of a token may be hidden data associated with the advertisement. This association may be appropriate for, for example, an advertisement 122 in an online context. In such a context the advertisement 122 is interactive such that a transaction request can be generated upon selection of the advertisement 122 (e.g. by a ‘click-through’ event). The advertisement 122 may comprise a hyperlink such that selection of the advertisement 122 transfers the potential purchaser to purchase webpage, such as a payment gateway or merchant site through which goods can be purchased, in which or from which a transaction can take place.

Where the token comprises hidden data, the token or token data is automatically passed to the purchase webpage (e.g. payment gateway) to modify the transaction occurring on the webpage and to associate the token data with that transaction. An example of a payment gateway 126 is shown in FIG. 2, where details 128 of the product being purchased are, in this example, shown on the left hand side of the gateway 126 and details of the transaction 130 (exclusive of product related details) are shown on the right hand side of the gateway 126.

With reference to step 102, a token is generated before completion of display of an advertisement. Once generated, the token is associated with the displayed advertisement 120, 122.

After display, or during display in the case of an interactive advertisement, a transaction is established 106. Establishing a transaction involves supplying all the details upon which a transaction can be executed, and all processes up to the time execution actually occurs. The payment may be established by selection of the advertisement 122 in an online context, or by subsequently supplying the token 118 when establishing a transaction using a manual means such as subsequent online purchase following a television commercial.

For online transactions and transactions involving interactive advertisements, the transaction will typically be established in a payment gateway. In these cases, the gateway may be automatically supplied the token upon selection of the advertisement. This enables the transaction to be established with modified credentials as discussed below, without requiring the purchaser to input the token.

It will be appreciated that a vendor will usually happily sell products and services regardless of whether a token is supplied when a transaction occurs. For this reason, the established transaction can take two forms.

In a first form, no token is provided when establishing the transaction 106. The transaction is therefore established (and subsequently executed) using default or ‘initial’ payment credentials. The initial payment credentials are those credentials that persist on all occasions except those where a transaction is modified, such as by using a token.

In a second form, a token, in the form of token data, is provided when establishing the transaction 106. In this circumstance the transaction modifier modifies the payment credentials for the transaction. Modifications can include measures such as:
discounting a transaction amount;
setting a purchase quantity to n (e.g. 2, 3 or any other number greater than 1) multiples of an advertised product or service, and setting the transaction amount to less than n-times a transaction amount for purchase of a unit of the advertised product or service;
adding an additional product or service to the transaction; and
providing promotional material to the purchaser. The token data may include an indicator of the medium (e.g. a particular television channel) on which the advertisement was displayed, and promotional material may be based on other types of products and services routinely advertised on the same medium. For example, where the purchaser is viewing the Discovery Channel®, and purchases a backpack displayed on that channel using a token, the promotional material may include hiking boots or other material generally associated with content shown on that channel.

In some cases, to evidence, for example, that a discount has been applied a payment gateway may display both unmodified (i.e. initial) payment credentials along with the modified payment credentials on which the transaction will take place—see reference numeral 132 in FIG. 2.

Once established, the transaction is executed 108. Executing a transaction involves a standard execution process whereby the payment gateway collects information about a transaction and enables an exchange of funds between the purchaser, the vendor and any relevant financial institutions.

After executing the transaction, data is stored 110 in a data repository 124 to facilitate future analysis. The data is stored as a data tuple which, in the present context, is any form by which one piece of data can be associated with one or more other pieces of data in memory. The present data tuple includes a record of the transaction which may be collected by the payment, the advertised content (particularly the goods or services purchased by the transaction) and at least one of the time data and the time of display.

As indicated by arrow 112 in FIG. 1, the above steps 102, 104, 106, 108, 110 will typically be repeated once for each transaction with which a token is associated. Thus the data repository 124 will ultimately contain a large number of data tuples representing past transactions.

Once stored, the data can be analysed 114 to determine, for example, the best times to advertise content and, similarly, the times during which to charge more for advertising space.

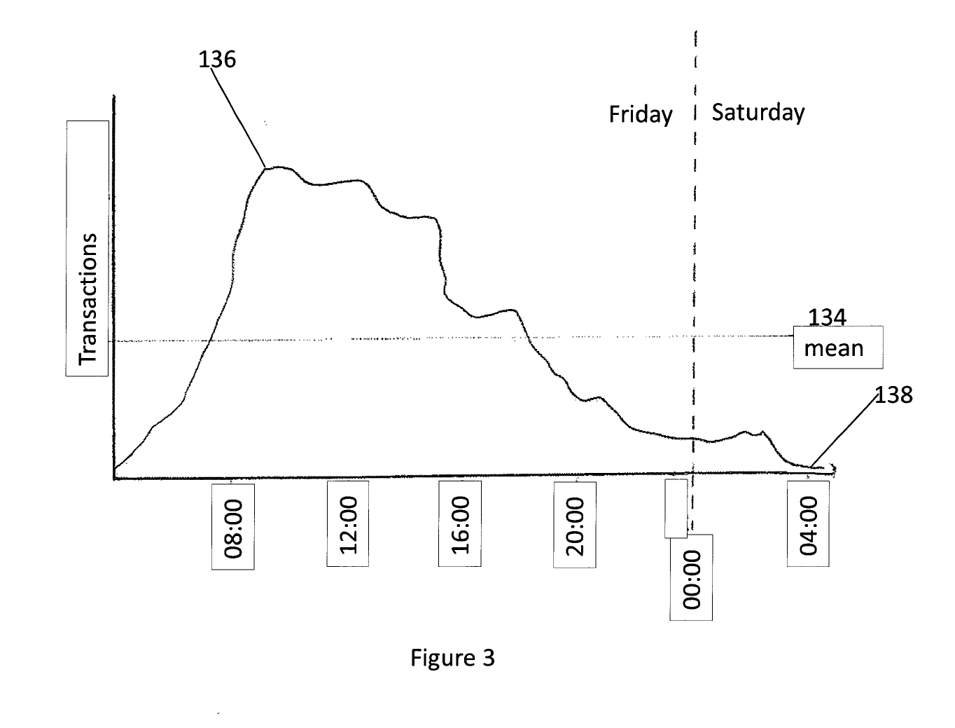

The times of display of the data tuples stored in the data repository may be analysed to identify a mean number of transactions for all times of display. FIG. 3 shows a plot of transactions associated with tokens for various times of display of an advertisement over a 24-hour period. In this case, the mean number of transactions per time of display 134 is shown. This enables peaks 136 and troughs 138 to be identifiable with reference to the mean number of transactions 134.

In this case the merchant is advertising over the full 24-hour period. In light of the analysis shown in FIG. 3, the merchant may decide to focus advertising budget on displaying advertisements between the hours of 5 am and 7 pm, apply a smaller budget between the hours of 7 pm and 9 pm and 11 pm to 11:30 pm, and not advertise at all outside those hours.

Similarly, the present analysis may facilitate automatic production of a pricing template or pricing strategy for pricing display of a future advertisement. The future advertisement may be priced for display at a future time of display, based on the number of transactions received at a comparable earlier time of display. For example, the pricing strategy may ascertain the mean number of transactions per time of display, identify peaks and troughs in a similar manner to that described above for manual advertising budget allocation by a merchant, and automatically propose an allocation of advertising budget targeting the times of display yielding heavier sales.

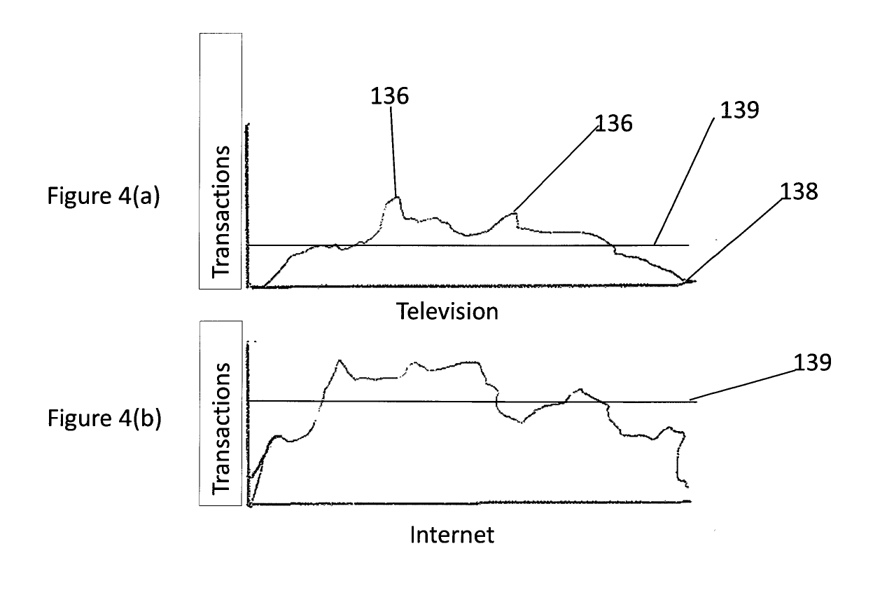

While FIG. 3 shows “Friday” and “Saturday”, any other days or time periods (e.g. weeks or months) may be used on the time scale. Moreover, a single 24-hour de-identified period may be displayed showing the average for sales over a 24-hour period without reference to the particular day on which the advertisement was displayed. This is shown by illustrative example in FIGS. 4(a), 4(b), and 4(c).

The token, or token data, may further include medium information defining an advertising medium on which the advertisement is displayed. This medium information may be stored in the data repository, in the data tuples along with the record of the transaction, advertised content and time of display for each transaction. This will enable transaction analysis to include information on which advertising medium yielded a particular transaction at a particular time of display.

The advantages of this approach can be seen in FIGS. 4(a) and 4(b). The line 136 of FIGS. 4(a) and 4(b) represents the transactions (Y-axis) executed for a particular time of display (X-axis) taken as an average of the total aggregate transactions for that time of display over a number of 24-hour periods. The average number of transactions per time of display over the 24-hour period 139 is also shown as a reference.

The graph for FIG. 4(a) shows the results of analysis for particular advertising medium, television, and the graph of FIG. 4(b) shows the results of analysis for a different advertising medium, the Internet. It can readily been seen that for the product in question, sales are significantly higher for Internet-based advertising than for television advertising. This might be expected, for example, where the product in question is appealing to socio-demographics who use social media more prolifically than other socio-demographics.

The token may also comprise channel information defining a channel of an advertising medium on which the advertisement is displayed. This channel information may be stored in the repository in the data tuples for each respective transaction. It follows that the number of transactions can then be analysed and displayed in association with the channel information.

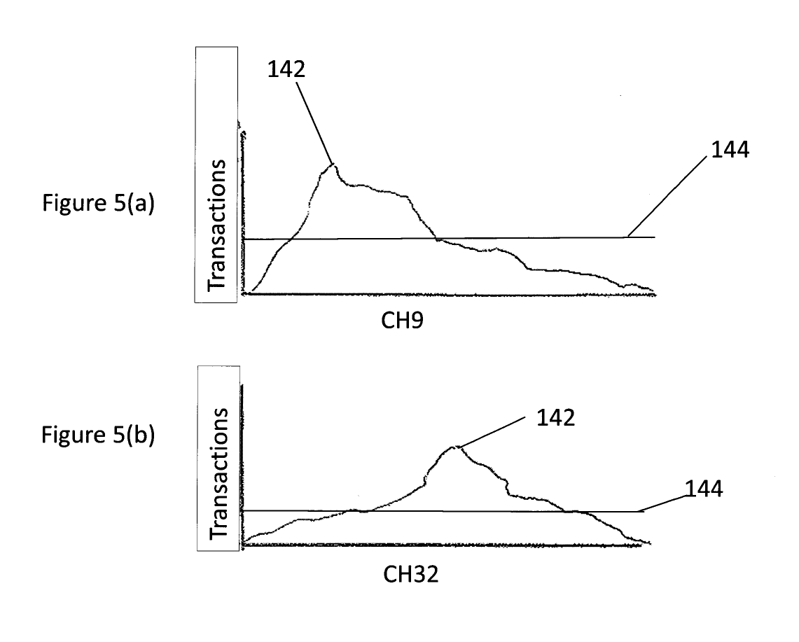

The advantages of this approach can be seen in FIGS. 5(a) and 5(b). Again, line 142 of FIGS. 5(a) and 5(b) represents the transactions executed for a particular time of display taken as an average of the total aggregate transactions for that time of display over a number of 24-hour periods. The average number of transactions per time of display over the 24-hour period 144 is also shown as a reference.

The graph for FIG. 5(a) shows the results of analysis for particular advertising channel on an advertising medium, presently television Channel 9, and the graph of FIG. 5(b) shows the results of analysis for a different advertising channel on the same advertising medium, presently television Channel 32. It can readily been seen that for the product in question, sales are significantly higher for Channel 32 than for Channel 9. This might be expected, for example, where the product in question is some form of outdoor equipment and Channel 32 relates to outdoor activity or lifestyle.

Also, it may be that a first channel achieves a greater number of transactions than other channels during some times of display in a 24-hour period, while a second channel achieves a greater number of transactions during different times of display in a 24-hour period. Thus more of an advertising budget may be allocated to one channel and/or advertising medium at some times of display, while other channels and/or advertising media are favoured at other times of display.

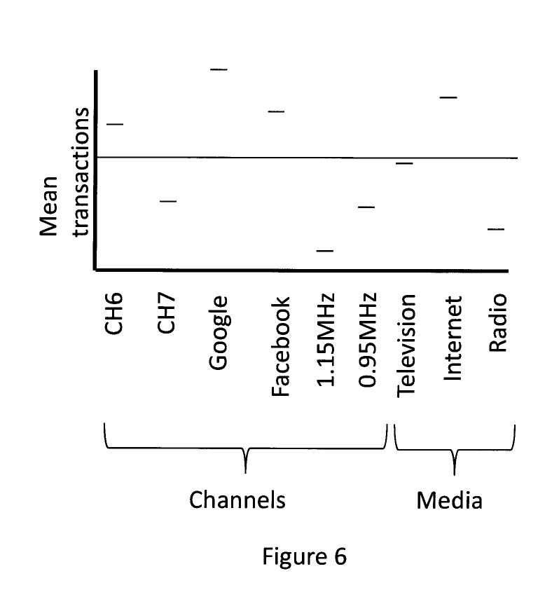

The graphical displays may display information in any desired manner. For example, the mean 140 in FIG. 4(b) may be set to be the same as mean 138 so as to be able to compare the transactions against the same base mean. Alternatively, the mean may be the mean for the particular advertising medium or channel as shown in FIGS. 4(a), 4(b), 5(a) and 5(b). Moreover, as shown in FIG. 6 the mean for various media and channels may be set on the same graph for comparison.

The data may also be displayed in another form, such as a table, by which transaction frequency or the number of transactions can be mapped to the times of display in which the transactions occurred.

Thus, using a token, transactions can be mapped to a time period or time of display during which a particular advertisement was displayed, and can also be mapped to the particular medium or channel on which it was displayed. The advertiser or vendor of the advertisement content will then understand the time period during which a successful sale was achieved. Thus an advertising medium provider can adapt the cost of advertising based on the number of transactions (for a particular merchant, an industry vertical or for a variety of merchants), or a merchant can adapt the budget allocation process, based on times of display, combinations of times of display and advertising medium depending on whether there was a higher or lower number of transactions than the average number of transactions for a previous comparable time of display.

Moreover, the payment gateway may collect data about when a transaction ultimately occurred. From this a merchant or advertising medium provider can understand the lag time between display of advertisement and sale.

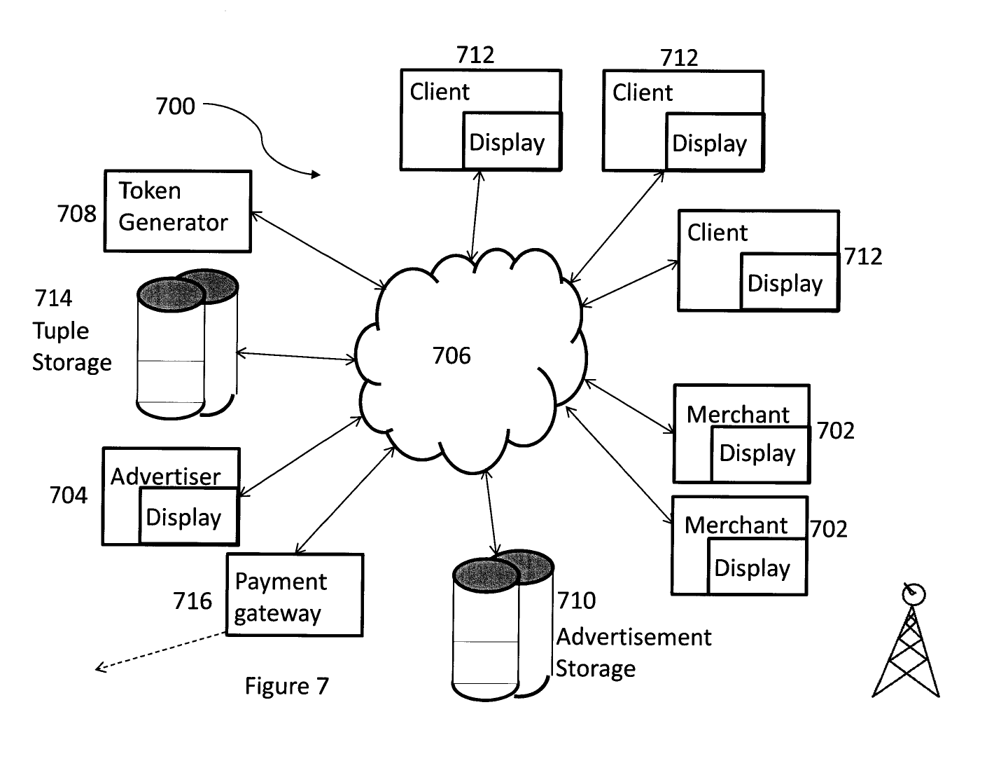

FIG. 7 illustrates a system, presently a network 700, over which the methods taught herein may be performed. The network 700 includes a plurality of merchant systems 702, an advertising system 704, a communication means 706, a token generator 708, advertising storage 710, client systems 712, data repository, presently embodied by tuple storage 714, and a payment gateway 716.

The communication means may be a wireless network, hardwired network, universal serial bus or any other means of communication that affords the necessary interaction between the parties involved in advertising and/or the subsequent transaction.

Merchant systems 702 are the computing systems of merchants who would like to sell an article (e.g. a good or service) through the clients 712—for the present embodiment, a single merchant will be involved with any particular advertisement though it will be understood that more than one merchant may be involved with any particular advertisement. One of the merchant systems 702 sends a request to the advertiser 704 over communication means 706, requesting creation of an advertisement, or to request display of an advertisement where one has been prior created. The advertisement is then pulled from advertisement storage 710. The advertisement storage 710 may constitute part of an independent third party system, the merchant system 702, the advertiser system 714 or any other appropriate storage location.

The advertiser system 704 allocates a timeslot and channel for display of the merchant's advertisement and requests a token from the token generator 708 to associate with that advertisement. The token generator 708 generates a token and sends the token, over communication means 706, to the advertiser system 704. The advertiser system 704 or token generator 708 also associate time data and a transaction modifier with the token to enable transactions to be mapped to particular instances of display of the merchant's advertisement.

The advertiser system 704 associates the token with the advertisement and advertises the merchant's advertisement and token (whether or not the token is hidden) on the client systems 712 over the communication means 706. Each client system 712 includes a display by which a consumer (not shown) can view the advertisement.

When a transaction is initiated, for example by a consumer, that transaction is initiated by sending a transaction request through one of the client system 712. Alternatively, the consumer can, in some instances, approach the relevant merchant directly. A transaction is then established upon receiving a transaction request either from the client system 712 or relevant merchant, relating to the content advertised in the advertisement.

That transaction is then executed, by the merchant and/or payment gateway 716. Execution of the transaction depends on whether or not the token is supplied along with the transaction request. Initial, or default, payment credentials are used for the transaction if the token is not supplied while establishing the transaction. However, the present system 700 will also often be applied to transactions established using the token. In this event, the transaction is executed using modified payment credentials. As discussed in relation to FIG. 1, the modified payment credentials are based on the initial payment credentials and the transaction modifier which modifies the initial payment credentials.

The transaction ultimately passes through a payment gateway for ongoing processing—for example, using an acquirer, payment scheme and issuer model. Such processing will be understood by the skilled person.

A record of each transaction, the advertised content purchased by that transaction and the token time data or the time of day at which the relevant advertisement was displayed, are then stored as a data tuple in a data repository, presently referred to as tuple storage 714.

This process will be repeated over time, with a large number of transactions such that a meaningful number of data tuples—in other words, data from which reasonable conclusions can be drawn as to those times slots, dates, advertising media, channels and so forth yield greater of fewer transactions than other time slots etc., dates, advertising media, channels and so forth—are stored in the tuple storage 714. The transactions will each be associated with a token which, in each case, may or may not be the same as a token associated another one of the transactions.

Once a meaningful number of data tuples are stored in the tuple storage 714, it can be analysed to generate a number of transactions for each time of display. The results of that analysis can then be displayed on the display of the advertiser system 704 or relevant merchant system 702, depending on which party (the advertiser or merchant) is performing the analysis, to enable visual identification of peak and troughs in the transaction frequency data. From this display of the result of analysis, conclusions can be drawn as to the efficacy and pricing of various advertising time slots, media, channels and so forth.

While the system 700 is, in the present embodiment, a network it will be appreciated that some components may be combined into single systems and other components may be added as needed. For example, the advertiser 704 and advertising storage may form parts of a single system. Similarly, the advertiser 704 and token generator 708 may form parts of a single system. Alternatively, a merchant 702 may produce the desired tokens and thus also constitute the token generator 708. All such modifications and adaptations are intended to fall within the scope of the present disclosure.

In addition, each of the merchant systems 702, advertiser system 704, client systems 712, token generator 708, payment gateway, tuple storage 714 and advertisement storage 710 may include or constitute a processor or any other computing system components necessary to achieve the desired functionality. Similarly, each of the merchant systems 702, advertiser system 704, client systems 712, token generator 708, payment gateway, tuple storage 714 and advertisement storage 710 may comprise a distributed system. With regard to the merchant and advertiser system, the processor that performs, for example, analysis of the data tuples may be located remotely (and indeed may even form part of a third party system) from the display on which the results of that analysis is displayed. All such components and variations are intended to fall within the scope of the present disclosure.

1. A method for mapping data to a transaction, comprising:
generating a token using a token generator, the token being associated with time data and a transaction modifier;
using an advertiser system in communication with the token generator to associate the token with an advertisement displayed at a time of display corresponding with the time data, the advertisement comprising advertised content received from one or more merchant systems;
establishing a transaction using a payment gateway upon receiving a transaction request, through a client system on which the advertisement is displayable or a respective said merchant system, relating to the advertised content;
executing the transaction, through the payment gateway, with initial payment credentials if the token is not supplied while establishing the transaction, and executing a transaction, through the payment gateway, with modified payment credentials if the token is supplied while establishing the transaction, the modified payment credentials being based on the initial payment credentials and the transaction modifier which modifies the initial payment credentials;
receiving and storing, at a data repository, a data tuple comprising a record of the transaction, the advertised content and at least one of the time data and the time of display;
repeating the above steps for multiple tokens;
analysing, at the advertiser system or the respective merchant system, the data tuples from the data repository to generate a number of transactions for each time of display; and
displaying the number of transactions and times of display on a display associated with the advertiser system or the respective merchant system, to enable visual identification of peaks and troughs in the transaction frequency data.

2. [symbol] method according to claim 1, wherein associating the token with an advertisement comprises associating hidden content with the advertisement.

3. A method according to claim 2, wherein the advertisement is interactive and the transaction request is generated upon selection of the advertisement, and establishing a transaction comprises accessing the payment gateway through which the transaction can be executed upon receipt of the transaction request.

4. A method according to claim 3, wherein establishing a transaction comprises automatically supplying the token to the payment gateway upon receipt of the transaction request.

5. A method according to claim 1, wherein establishing a transaction comprises displaying both the initial payment credentials and the modified payment credentials on a client system display when establishing the transaction with the modified payment credentials.

6. A method according to claim 1, wherein the initial payment credentials are automatically modified by the transaction modifier, by at least one of:
discounting a transaction amount;
setting a purchase quantity to n multiples of an advertised product or service, and setting the transaction amount to less than n-times a transaction amount for purchase of a single said advertised product or service;
adding an additional product or service to the transaction; and
providing promotional material to the purchaser.

7. [symbol] method according to claim 1, further comprising analysing, at the advertiser system or the respective merchant system, the respective times of display of the data tuples to identify a mean number of transactions for all times of display, and wherein the displaying step comprises displaying the mean number of transactions so that peaks and troughs are identifiable with reference to the mean number of transactions.

8. [symbol] method according to claim 1, further comprising producing, at the advertiser system, a pricing template for pricing display of a future advertisement, at a future time of display, based on the number of transactions as determined from the data tuples for a comparable time of display.

9. [symbol] method according to claim 1, wherein the token further comprises medium information defining an advertising medium on which the advertisement is displayed, and the storing step comprises storing the medium information with the record of the transaction, advertised content and time of display in the respective a data tuples.

10. [symbol] method according to claim 9, further displaying the number of transactions in association with the medium information.

11. [symbol] method according to claim 1, wherein the token further comprises channel information defining a channel of an advertising medium on which the advertisement is displayed, and the storing step comprises storing the channel information with the record of the transaction, advertised content and time of display in the respective a data tuples.

12. A method according to claim 11, further displaying the number of transactions in association with the channel information.

13. A method according to claim 1, wherein associating the token with an advertisement comprises displaying a visual element concurrently with the advertisement.

14. A method according to claim 13, wherein establishing a transaction comprises manually entering the token into a payment gateway.

15. A system for mapping data to a transaction, comprising:
a data repository for storing data tuples;
an advertiser system;
at least one merchant system;
a display associated with one of the advertiser and respective merchant system;
a token generator;
a client system; and
a payment gateway;
wherein:
the client system is configured to display an advertisement;
the respective merchant system is configured to send to advertised content to the advertiser system;
wherein at least one of the client system and respective merchant system is configured to send a transaction request to the payment gateway;
the token generator is configured to generate a token, the token being associated with time data and a transaction modifier;
the advertiser system is in communication with the token generator and configured to receive the token and associate the token with the advertisement, the advertisement being displayed at a time of display corresponding with the time data and comprising the advertised content;
the payment gateway is configured to establish a transaction upon receiving the transaction request from the client system or respective merchant system, relating to the advertised content, the payment gateway also being configured to execute the transaction with initial payment credentials if the token is not supplied while establishing the transaction, and with modified payment credentials if the token is supplied while establishing the transaction, the modified payment credentials being based on the initial payment credentials and the transaction modifier which modifies the initial payment credentials;
the data repository is configured to receive and store a data tuple comprising a record of the transaction, the advertised content and at least one of the time data and the time of display, along with a plurality of other data tuples similarly generated by the token generator, advertiser system, payment gateway, client system and respective merchant system;
wherein at least one of the advertiser system and respective merchant system is configured to analyse the data tuples from the data repository to generate a number of transactions for each time of display; and
the display is configured to display the number of transactions and times of display to enable visual identification of peaks and troughs in the transaction frequency data.

16. A system according to claim 15, wherein the advertiser system is configured to associate the token with the advertisement by associating hidden content with the advertisement.

17. A system according to claim 15, wherein the payment gateway is configured to automatically modify the initial payment credentials, using the transaction modifier, by at least one of:
discounting a transaction amount;
setting a purchase quantity to n multiples of an advertised product or service, and setting the transaction amount to less than n-times a transaction amount for purchase of a single said advertised product or service;
adding an additional product or service to the transaction; and
providing promotional material to the purchaser.

18. A system according to claim 15, wherein the advertiser system or the respective merchant system are configured to analyse the respective times of display of the data tuples to identify a mean number of transactions for all times of display.

19. A system according to claim 15, wherein the advertiser system is configured to produce a pricing template for pricing display of a future advertisement, at a future time of display, based on the number of transactions as determined from the data tuples for a comparable time of display.

20. A computer program embodied on a non-transitory computer readable medium for mapping data to a transaction, the program comprising at least one code segment executable by a computer to instruct the computer to:
generate a token using a token generator, the token being associated with time data and a transaction modifier;
use an advertiser system in communication with the token generator to associate the token with an advertisement displayed at a time of display corresponding with the time data, the advertisement comprising advertised content received from one or more merchant systems;
establish a transaction using a payment gateway upon receiving a transaction request, through a client system on which the advertisement is displayable or a respective said merchant system, relating to the advertised content;
execute the transaction, through the payment gateway, with initial payment credentials if the token is not supplied while establishing the transaction, and execute a transaction, through the payment gateway, with modified payment credentials if the token is supplied while establishing the transaction, the modified payment credentials being based on the initial payment credentials and the transaction modifier which modifies the initial payment credentials;
receive and store, at a data repository, a data tuple comprising a record of the transaction, the advertised content and at least one of the time data and the time of display;
repeat the above steps for multiple tokens;
analyse, at the advertiser system or the respective merchant system, the data tuples from the data repository to generate a number of transactions for each time of display; and
display the number of transactions and times of display on a display associated with the advertiser system or the respective merchant system, to enable visual identification of peaks and troughs in the transaction frequency data.
